(19) United States
(12) Patent Application Publication
(10) Pub. No.: US 2012/0229929 A1
(43) Pub. Date: Sep. 13, 2012

(54) MAGNETIC RECORDING MEDIUM AND MAGNETIC READING APPARATUS

(75) Inventor: Haruhiko IZUMI, Ome-shi (JP)

(73) Assignee: KABUSHIKI KAISHA TOSHIBA, TOKYO (JP)

(21) Appl. No.: 13/402,442

(22) Filed: Feb. 22, 2012

(30) Foreign Application Priority Data
Mar. 11, 2011 (JP) 2011-054765

(51) Int. Cl. G11B 5/09; G11B 5/82

(52) U.S. Cl. 360/51; 360/135

(57) ABSTRACT

According to one embodiment, a magnetic recording medium includes: a data area where a plurality of first magnetic dots are placed at predetermined positions to record information, the data area being formed on a surface of the magnetic recording medium; a servo area where a plurality of second magnetic dots for specifying the positions of the first magnetic dots are placed at predetermined positions, the servo area being formed on a surface of the magnetic recording medium; and servo address marks being doubly formed in the servo area, and subdivision being performed while boundary positions of second magnetic dots of one of the servo address marks and boundary positions of second magnetic dots of another one of the servo address marks are different from each other in a radial direction.

### CROSS REFERENCE TO RELATED APPLICATION(S)

The application is based upon and claims the benefit of priority from Japanese Patent Application No. 2011-054765 filed on Mar. 11, 2011; the entire contents of which are incorporated herein by reference.

### BACKGROUND

1. Field

An embodiment of the present invention relates to a magnetic recording medium, and also to a magnetic reading apparatus.

2. Description of the Related Art

The embodiment relates to a method of subdividing a servo pattern of a BPM (bit pattern medium). A magnetic film of a BPM is not a granular film but a continuous film. In a pattern of a large area, therefore, the coercive force is reduced by a diamagnetic field. Even when the magnetization direction of a servo pattern is initially magnetized, consequently, magnetization reversal is caused by stimulation such as a head touch.

As a countermeasure against this, a technique in which the area of a servo pattern is reduced by subdivision and the coercive force is ensured has been known. And, a known configuration detects a specific pattern from each of two sequences of data, i.e., a leading edge data sequence and a trailing edge data sequence.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a schematic diagram showing an embodiment of a magnetic recording apparatus including a magnetic recording medium;

FIGS. 2A and 2B are diagrams showing a sector structure of a magnetic disk medium of an embodiment which is included in a magnetic disk apparatus;

FIG. 3A is a plan diagram showing a surface of the magnetic disk medium of the embodiment, and FIG. 3B is a conceptual diagram showing magnetization states of data and servo areas;

FIGS. 4A to 4C show an example of a method subdividing a SAM pattern in the embodiment;

FIGS. 5A and 5B show an example of a configuration for detecting the SAM pattern in the embodiment;

FIG. 6 is a view showing an example of a method of subdividing the SAM pattern in another embodiment;

FIG. 7 is a block diagram of a servo signal demodulation circuit in the magnetic disk apparatus of the embodiment; and

FIG. 8 is an operation timing chart of the servo signal demodulation circuit in the magnetic disk apparatus of the embodiment.

### DETAILED DESCRIPTION

According to one embodiment, a magnetic recording medium includes: a data area where a plurality of first magnetic dots are placed at predetermined positions to record information, the data area being formed on a surface of the magnetic recording medium; a servo area where a plurality of second magnetic dots for specifying the positions of the first magnetic dots are placed at predetermined positions, the servo area being formed on a surface of the magnetic recording medium; and servo address marks being doubly formed in the servo area, and subdivision being performed while boundary positions of second magnetic dots of one of the servo address marks and boundary positions of second magnetic dots of another one of the servo address marks are different from each other in a radial direction.

Hereinafter, embodiments will be described.

### First Embodiment

A first embodiment will be described with reference to the figures.

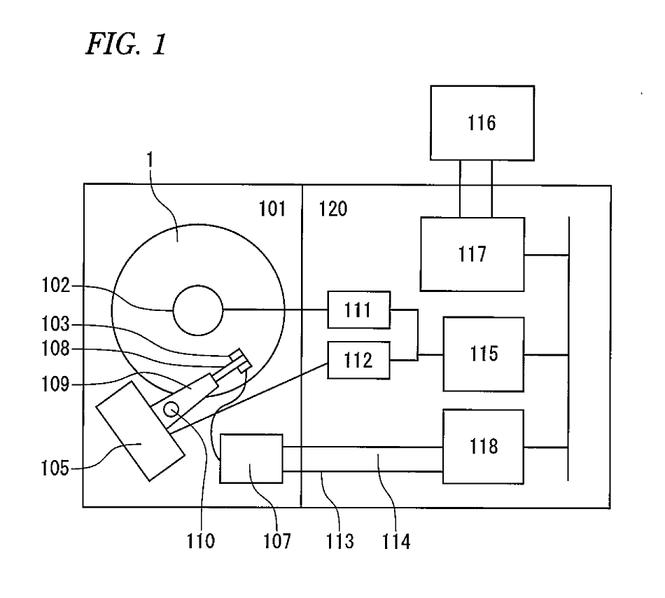

FIG. 1 is a schematic diagram showing a magnetic recording (reproducing) apparatus which is an embodiment of a magnetic reading apparatus including a magnetic recording medium that will be described later. The magnetic reading apparatus shown in FIG. 1 includes the disk-like magnetic recording medium (magnetic disk medium) 1 (hereinafter, a magnetic recording apparatus including a magnetic disk medium is referred to as a magnetic disk apparatus).

The magnetic disk apparatus includes a disk enclosure 101 and a circuit board 120.

The disk enclosure 101 is a container in which the magnetic disk medium 1, a spindle motor 102, a magnetic head 103, an actuator 105 including a voice coil motor (VCM) (not shown), a head gimbal assembly 108, a carriage arm 106, a shaft 110, a head amplifier 107, and the like are hermetically mounted. The magnetic disk medium 1 is attached to the spindle motor (SPM) 102. The magnetic head 103 includes at least one of a recording (write) element (not shown) which records magnetic information on the magnetic disk medium 1, and a reproducing (read) element (not shown) which has a function of taking out magnetic information recorded on the magnetic disk medium 1, as an electric signal. The recording element includes, for example, a write coil, a main magnetic pole layer, and an auxiliary pole layer. The write coil has a function to generate magnetic fluxes. The main magnetic pole layer has a function to store the magnetic fluxes generated in the write coil, and release the magnetic fluxes toward the magnetic disk. The auxiliary pole layer has a function to circulate the magnetic flux released from the magnetic pole layer via the magnetic disk. An example of the reproducing element is an MR element (magneto-resistance effective element). The magnetic head is mounted on the head gimbal assembly 108, and placed so as to be opposed to the magnetic disk medium 1.

As the magnetic disk medium 1, various magnetic recording media which will be described later may be used. The end of the head gimbal assembly 108 where the magnetic head 103 is not mounted is fixed to the tip end of the carriage arm 106. The carriage arm 106 can be swingingly driven by the VCM while using the shaft 110 as a rotation shaft. The swing driving enables the magnetic head 103 to scan the magnetic disk 1 in a substantially radial direction. When the magnetic head 103 is positioned on a desired recording track on the magnetic disk medium 1, the magnetic head 103 can write information to recording bits arranged in the recording tracks on the magnetic disk medium 1, or read information from the magnetic disk medium 1. The head amplifier 107 has a role of supplying a current to the recording element mounted on the magnetic head 103 based on a recording signal 113 to record data on the magnetic disk medium 1, or converting magnetization information on the magnetic disk medium 1 detected by the reproducing element of the magnetic head 103, into a reproducing signal 114.

The circuit board 120 includes a read channel 116, a micro processing unit (MPU) 115, a spindle motor (SPM) driver 111, a voice coil motor (VCM) driver 112, a disk controller 117, etc. The read channel 116 has a role of decoding the reproducing signal 114 (a servo signal or a data signal) from the head amplifier 107 to convert it into digital information, or converting information which is instructed to be recorded by the disk controller 117, into the recording signal 113 for driving the head amplifier 107.

The MPU 115 drives the VCM driver 112 to perform positioning control of the magnetic head 103, or drives the SPM driver 111 to perform rotation control of the magnetic disk medium 1, based on the digital information (servo information) of the servo signal decoded by the read channel 116.

The disk controller 117 has a role of instructing the MPU 115 to position the magnetic head 103 for addressing to the magnetic disk medium 1, by a recording/reproducing command from a host computer 118. The disk controller 117 also has roles of transmitting/receiving digital information to be recorded or reproduced to/from the read channel 116, and returning a result to the host computer 118.

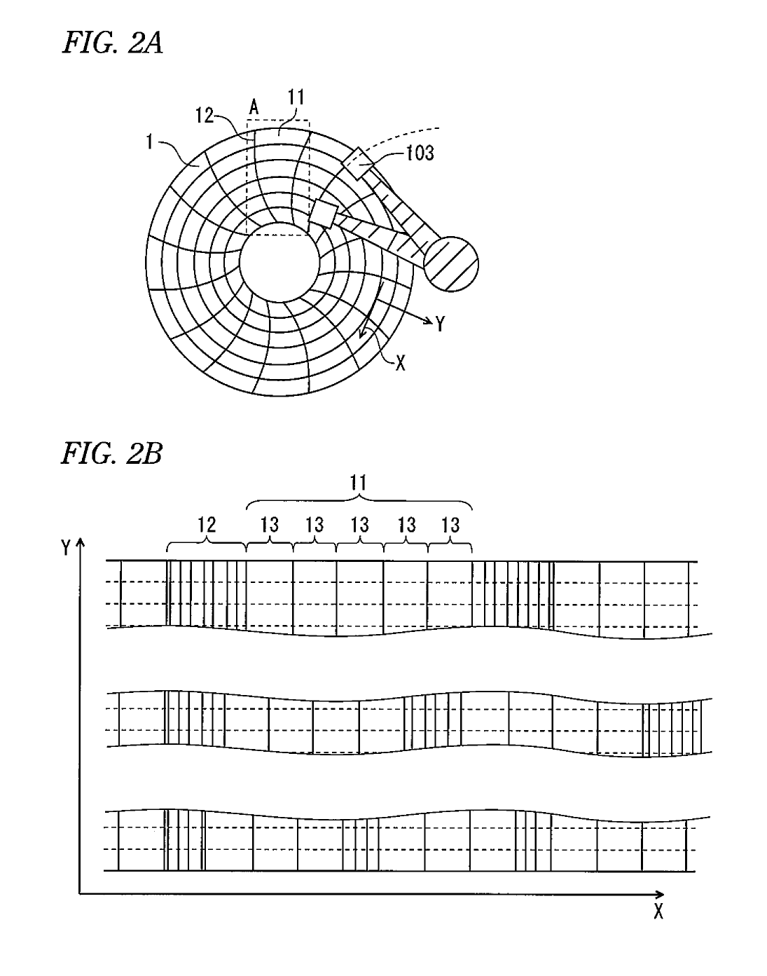

Hereinafter, an embodiment of the magnetic recording medium of the invention will be described with reference to FIGS. 2A and 2B et seq.

FIG. 2A is a plan diagram showing a sector structure of the magnetic disk medium of the embodiment which is included in the magnetic disk apparatus, and FIG. 2B is an enlarged view of a portion A in FIG. 2A. In the figures, the circumferential direction of the surface of the disk is set as the X-axis, and the radial direction is set as the Y-axis (this is applicable also to the subsequent figures).

Usually, a data area 11 and a servo area 12 are alternately arranged in the circumferential direction on the magnetic disk 1. Namely, the servo area 12 is intermittently disposed in a substantially circumferential strip centered at an approximate center of the magnetic disk medium 1. The data area 11 is disposed in the substantially circumferential strip and in a portion where the servo area 12 is not disposed.

The data area 11 is an area for storing data. In the data area 11, data sectors 13 which are storage areas for recording and reproducing are disposed in a period of predetermined length (track pitch) in the circumferential direction. Each data sector 11 includes magnetic dots (not shown). The shape and arrangement of the magnetic portion disposed in the data area 11 are referred to as the data pattern.

The servo area (servo sector) 12 is disposed in order to specify the position of magnetic dots included in the data area 11 (particularly, the position in the radial direction of the disk). The servo area 12 includes magnetic dots with various shapes in various arrangements as described later. The servo area 12 has an arcuate shape extending along the head access locus of the magnetic disk apparatus, and the circumferential length of the servo area is increased in proportion to the radial position. The shape and arrangement of the magnetic dots disposed in the servo area 12 are referred to as the servo pattern.

The magnetic head 103 acquires the position information of the magnetic head 103 by reading the reproducing signal generated by the magnetic dots included in the servo area 12 in a state where the magnetic disk medium is rotated. Based on the acquired position information of the magnetic head 103, the magnetic head 103 is positioned with respect to the track, and can record and reproduce data to and from the magnetic portion at a desired position of the data area 12.

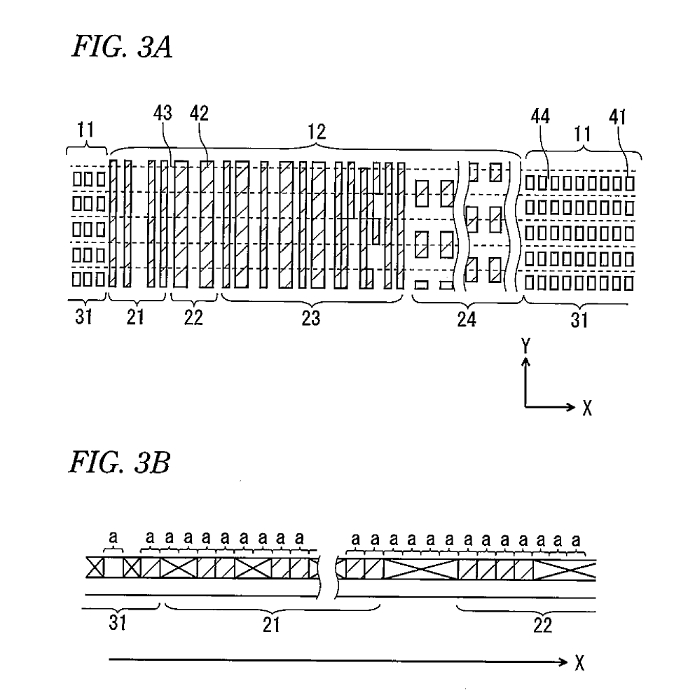

FIG. 3A is a plan diagram showing the surface of the magnetic disk medium of the embodiment, and FIG. 3B is a conceptual diagram showing magnetization states of the data and servo areas. The magnetic recording medium of the embodiment is a so-called patterned medium in which magnetic dots of the data area and those of the servo area are formed at predetermined positions.

In the data area 11, a plurality of magnetic dots (first magnetic dots) 41 are placed at predetermined positions. When the magnetic head scans over the first magnetic dots 41 in the magnetic disk apparatus, information bits a are formed. The term “placed at predetermined positions” in the above means that adjacent magnetic dots are intermittently placed according to a predetermined rule, i.e., in the circumferential direction (track direction). Usually, first magnetic dots which are adjacent to each other in the circumferential direction are placed at constant intervals. The structure of magnetic dots which are formed by the nanoimprint method or photolithography method which will be described later is an example of the placement at predetermined positions. By contrast, a structure (so-called granular structure) which is formed by dispersing magnetic particles in a non-magnetic member, and in which magnetic dots are irregularly placed is an example in which magnetic dots are not placed at predetermined positions.

The first magnetic dots 41 are formed of ferromagnetic polycrystals such as CoCrPt. In the peripheries of the first magnetic dots 41, non-magnetic substances 44 such as silica, alumina, or air are placed. Two adjacent first magnetic dots 41 are separated by the non-magnetic substance 44. In the magnetic disk apparatus, the recording element applies a desired magnetic field to each of the magnetic dots 41. The magnetizations of the magnetic dots 41 by the magnetic field can be held in a state where it is oriented in a desired direction. As described above, the magnetic dots can store magnetic information. Furthermore, the reproducing element reproduces magnetic information recorded in the first magnetic dots. In FIGS. 3A and 3B, the first magnetic dots 41 are shown by using different hatchings depending on their magnetization directions. In a magnetic disk medium of the perpendicular magnetic recording type, the magnetizations of the magnetic dots are oriented in the normal direction of the surface of the medium.

The servo area 12 includes a magnetic portion 42 and a non-magnetic portion 43. The magnetic portion 42 includes a plurality of magnetic dots (second magnetic dots) (not shown) and a non-magnetic member (not shown) which is placed so as to surround the magnetic dots. The second magnetic dots and the non-magnetic member will be described later. In a patterned medium, usually, the magnetizations of the second magnetic dots are oriented in the same direction. The non-magnetic portion 43 is formed of a non-magnetic member. When the magnetic head scans over the magnetic portion 42 and the non-magnetic portion 43 in the magnetic disk apparatus, information bits a are formed in accordance with magnetism and non-magnetism.

Depending on the function in a use in the magnetic disk medium, the servo area 12 can be divided into a synchronization signal generation portion 21, a synchronization signal detection portion 22, an address portion 23, and a micro position detection portion 24.

The synchronization signal generation portion 21 has a function to adjust the amplification factor of the signal amplifier before reading the servo information, to make the amplitude constant, and to generate a sampling timing of the A/D converter (Analog to Digital converter) clock signal. The synchronization signal generation portion 21 includes magnetic portions which are continuous in all or a part of the range from the inner circumference of the medium to the outer circumference in the radial direction, and which are formed at predetermined intervals in the circumferential direction.

The synchronization signal detection portion 22 has a characteristic pattern which indicates the start of the servo information. The synchronization signal detection portion 22 includes a single magnetic portion having a bit length which is longer than the synchronization signal generation portion in the circumferential direction, or a plurality of magnetic portions which produce a predetermined code of a several-bit length.

The address portion 23 is an ID pattern which indicates a track number and sector number for each servo frame. In the magnetic recording apparatus, the address portion indicates a track position where the magnetic head is located. The address portion 23 includes a magnetic member which is continuous in all or a part of the area from the inner circumference to the outer circumference of the medium in the radial direction in a circumferential direction position indicating the sector number, which is continuous in all or a part of a range from the inner circumference to the outer circumference of the medium in the radial direction in a circumferential direction position indicating the higher digits of the track number, or which is intermittent in the radial direction of the medium in the circumferential direction position indicating the lower digits of the track number.

The micro position detection portion 24 is disposed in order to detect deviation information of the magnetic head position from the track center in the magnetic recording apparatus. An example of the micro position detection unit 24 is a configuration which has one or two kinds of magnetic patterns having a specific shape and arrangement in the circumferential direction, and the magnetic patterns are placed at equal intervals in the radial direction of the medium, for each track. Another example of the micro position detection unit 24 is a configuration formed by a strip-like magnetic pattern in which the longitudinal direction is not parallel to the radial direction of the disk over a plurality of tracks (hereinafter, such a pattern is referred to as a diagonal strip-like magnetic pattern).

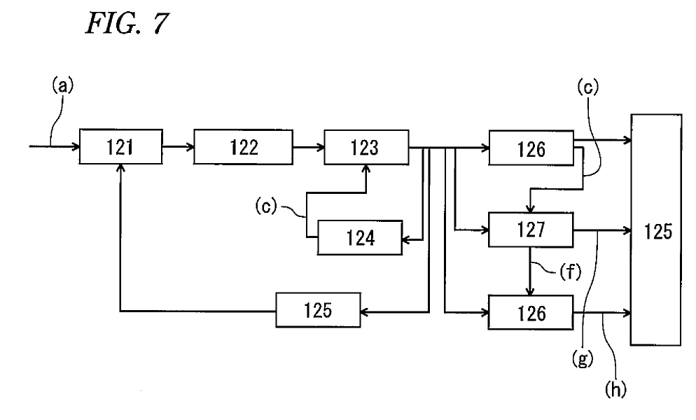

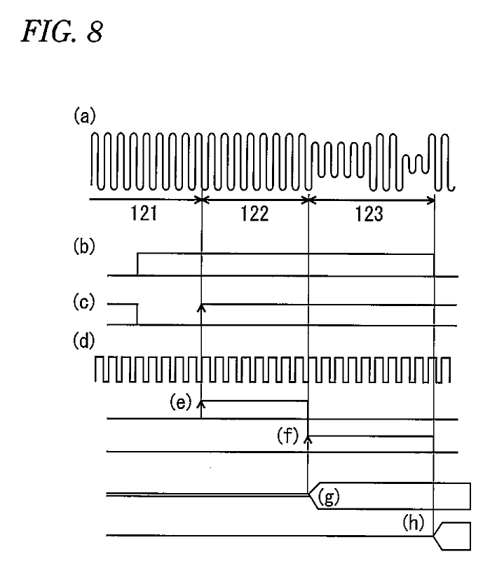

FIG. 7 is a block diagram showing the operation of the read channel 116 for reading the servo information on the magnetic disk medium when the MPU performs positioning control of the magnetic head in the magnetic recording apparatus including the magnetic disk medium of the embodiment. FIG. 8 is an operation timing chart of the read channel.

When the magnetic disk medium 1 is rotated at a predetermined angular velocity, the servo pattern reproducing signal (a) is obtained from the head amplifier at a constant time interval. After the high frequency noise component is blocked by a low-pass filter 122 in the read channel 116, the servo pattern reproducing signal (a) is A/D-converted by an A/D converter 123. Based on digitized amplification information, a gain controller 125 adjusts a variable gain 121 so as to obtain an optimum amplitude.

A pattern of a constant period is written in a servo pattern introductory portion as the synchronization signal generation portion 21. A servo gate signal (b) is previously asserted so that a wave number which is sufficient for a phase lock loop (PLL) circuit 124 to converge is obtained.

When the servo gate signal (b) is asserted, PLL is applied on the synchronization signal of the synchronization signal generation portion. Then, the PLL circuit 124 generates an ADC clock signal (d) which is necessary to sample the address portion and micro position detection portion that thereafter appear in the servo pattern reproducing signal.

A servo sync mark pattern which indicates the start of servo information is written in the end of the synchronization signal generation portion of the servo pattern, by a constant length of bits or specific code pattern bits. When the pattern is detected, a synchronization pattern detection signal (c) is asserted.

A synchronization signal detector 126 recognizes the assertion of the synchronization pattern detection signal (c), and transmits an address detection gate signal (e) to an address demodulator 127, thereby allowing the address portion which is subsequently reproduced, to be demodulated.

When the demodulation of the address portion of a default length is ended, an address demodulated value (g) is fixed and recorded in a register 129 as digital information. Moreover, a burst gate signal (f) is subsequently asserted, and a fine position demodulator 128 starts demodulation of the fine position detecting portion.

When the demodulation of the fine position detecting portion of a default length is ended, a fine position demodulated value (h) is fixed and recorded in the register 129 as digital information.

The MPU 115 reads the address demodulated value (g) and fine position demodulated value (h) which are stored in the register in the above-described operations, performs calculation necessary for positioning control of the magnetic head, and then drives the VCM driver 112.

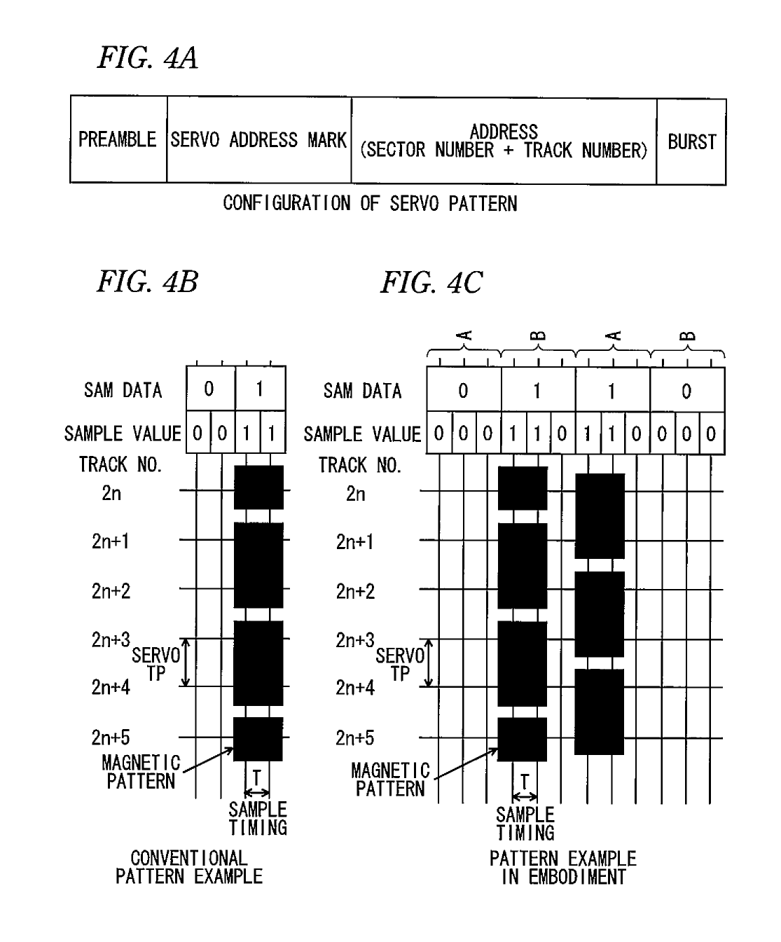

FIG. 4A shows an example of the configuration of the servo pattern. The servo pattern is configured so that, behind a preamble area for clock synchronization, a servo address mark (SAM) which functions as the reference timing of reproduction of the servo signal is formed, an address pattern indicating the sector number and the track number is formed, and a burst pattern for detecting the position of the head is formed.

FIG. 4B shows a conventional example of a SAM pattern in the case of BPR (Bit Pattern Recording). In BPR, a magnetic film in which the interparticle exchange coupling is strong is used so that, even when a plurality of magnetic particles exist in a data dot, the dot acts as a single domain. In a large-area pattern such as a servo pattern, therefore, the coercive force is reduced by a diamagnetic field, and, when the magnetization direction is initialized, magnetization reversal may spontaneously occur. As a countermeasure against this, the area of the servo pattern is subdivided into patterns of a smaller area, so that the coercive force can be ensured. In FIG. 4B, a pattern is divided every 2× servo Tp.

The conventional example has the problem of deterioration of the servo signal. When the read head passes through a subdivision position, the amplitude of a reproduction waveform is deteriorated. In the servo pattern, particularly, a SAM signal is used for obtaining the reference timing of demodulation of the address signal and a burst signal, and hence must be surely detected with an error rate which is sufficiently low. Therefore, a method of correctly detecting a SAM without being affected by deterioration due to subdivision is required.

FIG. 4C shows an example of the embodiment. A pattern in which two kinds of SAM signals that are indicated respectively by A and B in the figure are alternately arranged one bit by one bit is produced so that subdivision positions are different from each other. For example, when the read head passes through the subdivision position of the SAM pattern of A, therefore, the SAM signal of A is deteriorated, but the SAM signal of B can be correctly detected without being deteriorated, because the head does not pass through the subdivision position of B. By contrast, when the read head passes through the subdivision position of the SAM pattern of B, the SAM signal of A can be correctly detected because the head does not pass the subdivision position of the SAM of A. Even when the read head passes through any position, therefore, at least one of SAMs of A and B can be correctly detected.

The sample values corresponding to 1 and 0 of the SAM data are set to 110 and 000 in place of 11 and 00 in the conventional example, in order that the patterns of A and B are continuously connected to each other. In the example, “0” which is added to the sample values may not be used in the SAM detection. In this case, there is no problem even when “0” cannot be reproduced as 0.

In order to enable the SAM to be correctly detected by a detection system which will be described, however, the SAM data patterns of A and B must be different from each other. In an example where, in A and B, 1 and 0 are in an inversion relationship such as a case where A is “001100001010” and B is “110011110101”, the SAM data is “010110100101010110011001”.

Next, a configuration example of a conventional SAM detection system will be described. At each synchronization clock (not shown) synchronized by the preamble, a sample value signal which is sampled from a reproduced waveform by an ADC, and which is waveform processed by an FIR filter is sent to a register to be shifted, a coincidence comparison circuit compares the shifting with a detection pattern, and a timing when coincidence with the detection pattern is attained is obtained. The signal at the timing is delayed to obtain a timing of starting address demodulation and that of starting burst demodulation. In the detection of coincidence with the detection pattern, an error of about 1 or 2 bits may be sometimes allowed.

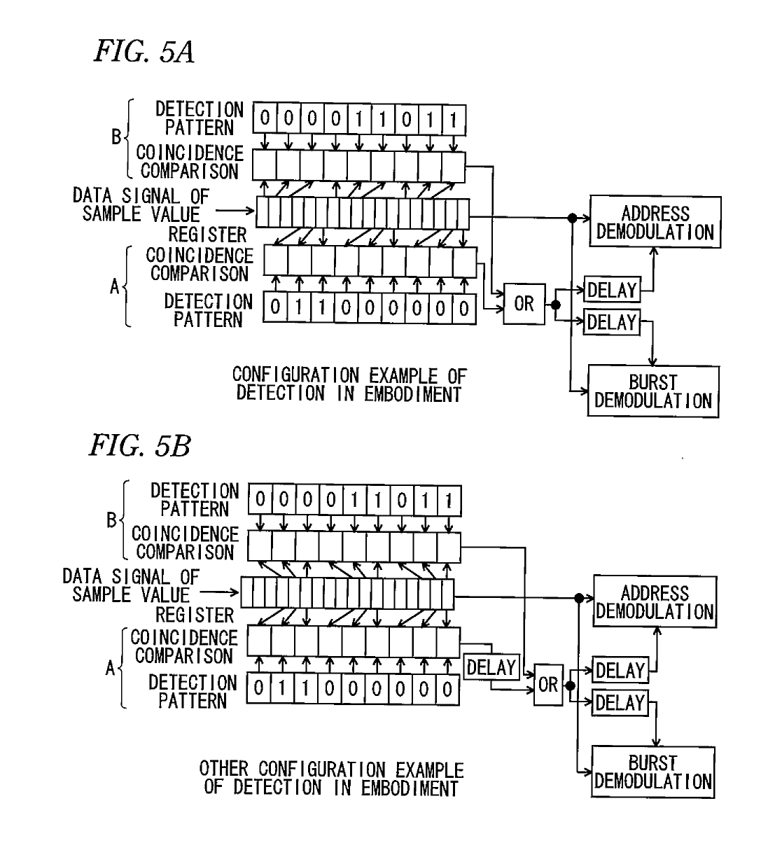

By contrast, FIG. 5A shows a configuration example of detection in the SAM system in the embodiment. A sample value signal which, similarly with the conventional example, is sampled from a reproduced waveform by an ADC, which is waveform processed by an FIR filter, and which is shifted in a register is monitored by two coincidence comparison circuits corresponding to the double SAMs indicated by A and B in FIG. 4C, and timings when coincidences with the the detection patterns are respectively attained are found. The head initially reproduces A and performs reproduction in the sequence of A→B→A→B. The sequence corresponds to expansion in which 1 bit of a SAM is expanded to 3 bits of sample value data. For the sake of clarity, the figure exemplarily shows only a portion related to the detection pattern corresponding to the upper 3 bits of a SAM.

As described above, the SAM data patterns of A and B are different from each other. In the process of shifting the sample value signal of a SAM, therefore, both the coincidence comparison circuits for A and B do not detect two or more times the SAM, and both the detection timings are identical with each other. Therefore, a logical sum (OR) of the two detection timings is taken. When at least one of the SAMs is detected, consequently, address demodulation and burst demodulation can be performed.

The number of bits of SAM data in which an error is allowed is indicated by N. In order to prevent two SAM data patterns from being erroneously detected, the SAM data patterns must be different from each other in (N+1) bits or more bits. Furthermore, in order to reduce the possibility that the patterns are erroneously detected, it is preferred to increase the hamming distance between the SAM data patterns. In the case where the patterns are mutually inverted as described above, the probability of error detection is smallest. The Levenshtein distance is known as a distance which is obtained by normalizing the hamming distance. The Levenshtein distance is regarded as normalization of the hamming distance which is used in substitution edition with respect to words of the same number of letters. In the case where SAMs of different numbers of letters are used, however, the Levenshtein distance may be used.

FIG. 5B shows a configuration example of another method with respect FIG. 5A. In this example, the coincidence comparison circuit of A detects a SAM before that of B, and hence detection timings of A and B are different from each other. Therefore, a delaying circuit for 1 bit of a SAM (3 bits of sample value data) is used so that the detection timings of A and B coincide with each other, and then a logical sum (OR) of the two detection timings is taken.

### Second Embodiment

A second embodiment of the embodiment of the invention will be described with reference to the figures. Description of components which are common to the first embodiment is omitted.

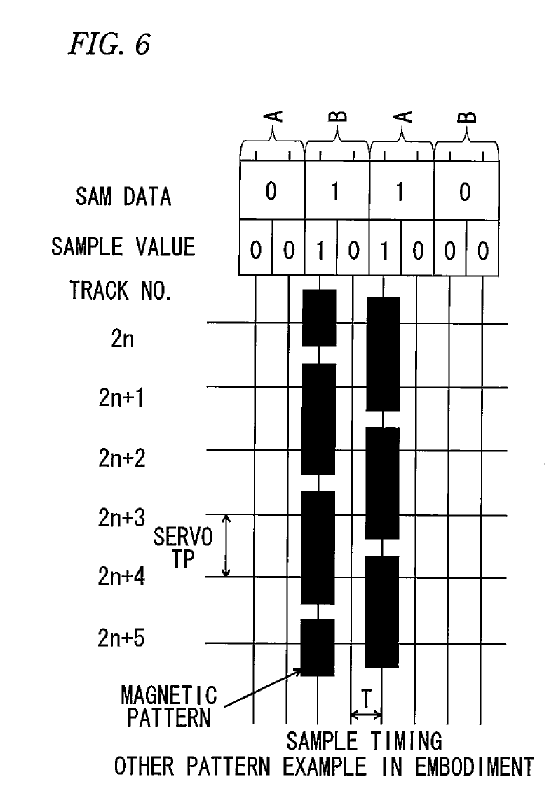

FIG. 6 shows an example of a method of subdividing a SAM pattern in the embodiment. In the example, a pattern in which the sample values corresponding to 1 and 0 of SAM data are set to 10 and 00 is used. The sample value requires only 2 bits for 1 bit of the SAM data. Therefore, the length of the whole SAM pattern can be shortened as compared with the first embodiment.

In the example, “0” of the second bit of each sample value may not be used in the SAM detection. In this case, there is no problem even when “0” cannot be reproduced as 0.

As described as effects in the example, even when the read head passes through any radial position, at least one of doubled SAMs can be detected correctly and surely. There are the following variations of the embodiment.

(1) In subdivision of a servo address mark (SAM) in a servo pattern of a bit patterned medium, doubled SAMs are produced, the radial subdivision position of one of the SAMs is different from that of the other SAM.
A. The bits of the doubly produced SAM data are sequentially alternately arranged.
B. The bit number of the sample number of each bit of the SAM data which are alternately arranged is increased by one, and a nonmagnetic pattern is made correspondent.
C. One of the doubly produced SAMs has a data pattern which is different from that of the other SAM.
(2) In order to detect the SAMs of (1), two coincidence comparison circuits detect timings coincident with detection patterns which correspond to the doubly produced SAMs, respectively, from a reproduced sample value signal which flows in a register while being shifted at each synchronization clock.
A. A logical sum (OR) of the detection signals of the SAMs is taken. When at least one of the SAMs is detected, address demodulation and burst demodulation can be performed.
B. The difference of the detection timings of the SAMs in A is corrected by a delaying circuit.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a data area comprising a plurality of first magnetic dots at first positions to record information, the data area on a surface of the magnetic recording medium;
a servo area comprising a plurality of second magnetic dots at second positions to specify positions of the plurality of first magnetic dots, the servo area on the surface of the magnetic recording medium; and
servo address marks in the servo area doubly, and divided such that boundary positions of second magnetic dots of one of the servo address marks and boundary positions of second magnetic dots of another one of the servo address marks are different from each other in a radial direction.

2. The magnetic recording medium of claim 1, wherein
bits of data of the servo address marks are placed sequentially and alternately.

3. The magnetic recording medium of claim 2, wherein
a number of sample value bits of each of the bits of data is increased by one, and a nonmagnetic pattern corresponds to the increased sample value bit.

4. The magnetic recording medium of claim 1, wherein
one of the servo address marks has a data pattern different from a data pattern of another servo address mark.

5. The magnetic recording medium of claim 4, wherein
a difference between the servo address marks of the data pattern is formed to maximize a coding distance.

6. A magnetic reading apparatus comprising:
a magnetic recording medium comprising:
a data area comprising a plurality of first magnetic dots at first positions to record information; and
a servo area comprising a plurality of second magnetic dots at second positions to specify positions of the first magnetic dots,
servo address marks in the servo area doubly, and divided such that boundary positions of second magnetic dots of one of the servo address marks and boundary positions of second magnetic dots of another one of the servo address marks are different from each other in a radial direction;
a register configured to store sample value bits of bits of the servo address marks; and
two comparison circuits configured to compare values of two kinds of detection patterns with a value of the register, wherein
the two comparison circuits are configured to detect timings coincident with detection patterns corresponding to the servo address marks from a reproduced sample value signal of the magnetic recording medium, the reproduced sample value signal configured to be input in the register and shifted at each synchronization clock to detect the servo address marks.

7. The magnetic reading apparatus of claim 6, wherein
when a logical sum of detection signals of the servo address marks is determined and at least one of the servo address marks is detected, address demodulation and burst demodulation is configured to be performed.

8. The magnetic reading apparatus of claim 6, wherein
when a difference of detection timings of detection signals of the servo address marks is corrected by a delaying circuit, a logical sum of the detection signals is determined, at least one of the servo address marks is detected, and address demodulation and burst demodulation are performed.

9. The magnetic recording apparatus of claim 6, wherein
bits of data of the servo address marks are placed sequentially and alternately.

10. The magnetic recording apparatus of claim 9, wherein
a number of sample value bits of each of the bits of data is increased by one, and a nonmagnetic pattern corresponds to the increased sample value bit.

11. The magnetic recording apparatus of claim 6, wherein
one of the servo address marks has a data pattern different from a data pattern of another servo address mark.

12. The magnetic recording apparatus of claim 11, wherein
a difference between the servo address marks of the data pattern is formed to maximize a coding distance.
